(19) United States
(12) Patent Application Publication
(10) Pub. No.: US 2026/0158600 A1
(43) Pub. Date: Jun. 11, 2026

(54) METHOD FOR MANUFACTURING A TEMPERATURE CONTROL SEGMENT THROUGH WHICH A LIQUID CAN FLOW

(71) Applicant: MAHLE International GmbH, Stuttgart (DE)

(72) Inventors: Karl-Gerd Krumbach, Burgstetten (DE); Marc Zitzelsberger, Fellbach (DE); Cord Voelker, Backnang (DE); Jochen Lakner, Durlangen (DE)

(21) Appl. No.: 19/415,726

(22) Filed: Dec. 10, 2025

(30) Foreign Application Priority Data
Dec. 11, 2024 (DE) 102024137116.1

(51) Int. Cl. B23P 15/26; B21D 53/06; H01M 10/6557

(52) U.S. Cl. CPC B23P 15/26; B21D 53/06; H01M 10/6557

(57) ABSTRACT

A method includes providing a pipe arrangement having components for fluid flow pre-fixed thereto. The pipe arrangement and the pre-fixed components are subjected to a soldering treatment, wherein they are simultaneously soldered together and soft annealed to form a structural unit. This structural unit is subsequently shaped in a forming treatment.

### CROSS-REFERENCE TO RELATED APPLICATION

This application claims priority to German Patent Application No. DE 102024137116.1, filed on Dec. 11, 2024, the contents of which is hereby incorporated by reference in its entirety.

### TECHNICAL FIELD

The present disclosure relates to a method for manufacturing a temperature control segment for controlling the temperature of a battery system. The disclosure also relates to such a temperature control segment, an inter-cell temperature control device for controlling the temperature of a battery system, and a battery system.

### BACKGROUND

Modern electric and hybrid vehicles use powerful battery systems with battery cells such as Li-ion cells. The battery cells are usually arranged along a stacking axis to form a battery cell stack. Measures for regulating the temperature of the battery cells are integrated into the battery cell stack, allowing waste heat to be removed from the battery cell stack or heat to be transferred to the battery cell stack as required. This allows the battery cells to be operated within a specified temperature range, ensuring their performance and longevity. The temperature control measures regularly include temperature control segments integrated into the battery system, for example channels arranged between two adjacent battery cells, which are flushed with fluid to achieve the aforementioned heat transfer.

The present disclosure has set itself the task of demonstrating an improved, in particular a more economical, manufacturing method for such a temperature control segment. Furthermore, such a temperature control segment, an advantageous inter-cell temperature control device for controlling the temperature of a battery system, and an advantageous battery system shall be specified.

### SUMMARY

In the present disclosure, these tasks are solved by the subject matter of the independent claim(s). Advantageous embodiments are the subject of the dependent claims, the description, and the drawings.

The first task is solved by a method for manufacturing a temperature control segment for controlling the temperature of a battery system, wherein in one step a) a pipe arrangement extending along a central axis, preferably straight (i.e., without curvature), at least two-or multi-flow (i.e., two-or multi-channel) pipe arrangement extending along a central axis is provided, which has a first axial pipe end with at least two first axial openings and a second pipe end axially opposite to this with at least two second axial openings. In a subsequent step b), at least two components for fluid conduction are provided, wherein a first of the two components is arranged at the first pipe end, preferably by being pushed onto or inserted into the first pipe end, and is fixed thereto, preferably by caulking, in particular clinching, and wherein a second of the two components is arranged at the second pipe end, preferably by being pushed onto or inserted into the second pipe end, and is fixed to the same, preferably by caulking, in particular clinching. In a subsequent step c), the pipe arrangement and the two components are simultaneously soldered together and soft annealed as part of a soldering process, preferably using a continuous furnace, so that a coherent structural unit is formed through which a fluid, preferably in a U-shape, can flow. In a subsequent step d), the said structural unit is plastically formed, preferably cold formed, as part of a forming process, preferably using a press. In this context, it is advantageous if, in step d), only the pipe arrangement of the structural unit is plastically deformed, preferably cold-formed.

The soft annealing of the structural unit provided for in step c) during the soldering process eliminates or reduces crystalline defects (so-called lattice defects or crystal structure defects), such as dislocations, as well as stress peaks in the material of the pipe arrangement and in the material of the components to a certain extent. This results in improved formability, in particular cold formability, of the structural unit provided in step d). In addition, this improves the handling of the soldered structural unit during the method, as experience has shown that the soft-annealed structural unit is comparatively insensitive to unwanted changes in shape that can result, for example, from transport of the structural unit following step c), storage of the structural unit, or impacts on the structural unit.

The pipe arrangement in question can preferably be formed by a (single) one-piece and/or two-or multi-flow (i.e., two-or multi-channel) pipe; for example, it can be realized by a multi-port extrusion pipe (MPE pipe). The pipe in question can be provided in step a) in a straight line, i.e., without any bends. The pipe arrangement or the pipe in question can also be provided in step a) as a flat pipe with, for example, a substantially rectangular cross-section. The pipe in question is also made of metal, enabling efficient heat transfer between the fluid flowing through the temperature control segment and a battery located on the temperature control segment. The pipe in question, in particular the MPE pipe, can be supplied cost-effectively and in large quantities, enabling economical production of the temperature control segment.

Alternatively, the pipe arrangement in step a) may consist of at least two or more separate pipes, each with one, two, or more flows. Conveniently, the at least two pipes mentioned in step a) of the proposed method each extend along a central axis and each have a first pipe end with at least one first axial opening and a second pipe end axially opposite to this with at least one second axial opening. In a step x) to be performed between step a) and step b), it may be provided that the at least two pipes are arranged parallel to each other, with first pipe ends adjacent to each other and second pipe ends adjacent to each other. The at least two pipes mentioned in step a) can each be designed to be straight, i.e., without any curvature. The at least two pipes mentioned are preferably provided in step a) as flat pipes with, for example, a substantially rectangular cross-section or as folded pipes. Furthermore, the at least two pipes are each made of metal, enabling advantageous heat transfer between the fluid flowing through the temperature control segment and a battery arranged on the temperature control segment.

For practical purposes, a “flat pipe” is defined here as a pipe arrangement or a pipe that has two large sides and two narrow sides, each of which are parallel and opposite each other. The large sides and narrow sides of such a pipe arrangement or pipe conveniently limit a flowable pipe volume, which is divided into two or more flows in particular. The pipe volume and/or the two or more flows may each be equipped with a rectangular or substantially rectangular flow cross-section.

It may also be expedient to provide that, in step d), the plastic deformation of the structural unit or the pipe arrangement of the structural unit is carried out in multiple stages. The disclosure understands the term “multiple stage” to mean plastic forming in successive, discrete forming stages. In this context, it may be expedient if, in step d) during the multiple stage plastic forming of the structural unit or the pipe arrangement of the structural unit: In a first forming stage, a pipe center of the pipe arrangement, which is formed by a section of the pipe arrangement arranged centrally or essentially centrally between the two pipe ends of the pipe arrangement, is formed and/or the pipe arrangement is fixed in place via its formed pipe center, preferably on a frame of the press, and then, in a subsequent second forming stage, the pipe ends of the pipe arrangement are positioned correctly, preferably by calibrating the pipe ends, formed, and the pipe arrangement is fixed in place via its formed pipe ends, preferably on a frame of the press. In a subsequent third forming stage, it is envisaged that a first intermediate pipe section of the pipe arrangement, which is formed by a section of the pipe arrangement arranged axially between the first pipe end and the pipe center, and/or a second intermediate pipe section of the pipe arrangement, which is formed by a section of the pipe arrangement arranged axially between the second pipe end and the pipe center, is or are formed. The multiple discrete forming stages enable controlled and therefore dimensionally accurate plastic forming of the soldered structural unit. In particular, cold working of the pipe arrangement is achieved, resulting in a 2% to 6% increase in strength. Furthermore, the first intermediate pipe section and/or the second intermediate pipe section may each be divided into several subsections, wherein the subsections of the first intermediate pipe section and/or the subsections of the second intermediate pipe section may be formed simultaneously or sequentially during the third forming stage.

The term “formed” used above refers to plastic forming. The aforementioned “calibration of the pipe ends” is conveniently achieved by positioning the pipe ends in a predetermined position after the first forming stage, for example by drawing and/or aligning. This allows any distortion of the pipe arrangement that may have occurred during the first forming stage to be compensated for as a result of the plastic forming of the pipe center, and the subsequent plastic forming of the remaining sections of the pipe arrangement in the second and third forming stages to be carried out with comparatively high dimensional accuracy.

It is expedient if the structural unit in step d) is formed in a suspended state, preferably in a press for suspended forming of structural units. It may be provided that the structural unit, when suspended, is or will be suspended, for example, via the first component and/or via the second component and further, for example, on a conveyor unit of the device for suspended transport of the structural unit. Alternatively, the structural unit can be formed in a horizontal position in step d), for example in a press for horizontal forming of structural units.

In a further embodiment of the disclosure, it may be provided that in a step e), preferably to be carried out after step d), the structural unit, preferably in a suspended state, is checked for leaks as part of a leak test, in particular by means of a helium leak test. This ensures that the structural unit is sealed and that fluid can flow through it without leakage during normal operation.

It may be expedient to provide that, in a step f) to be carried out preferably after step e), at least one coating is applied to the structural unit, which is preferably in a suspended state. A preferred coating may be, for example, an electrical insulating layer. The coating can preferably be applied as a spray coating. Furthermore, the coating can only be applied partially to the structural unit, for example to an inside surface of the structural unit or an outside surface of the structural unit.

In a further embodiment of the disclosure, it may be provided that in a step g), preferably to be carried out after step e) or step f), the structural unit is tested for its insulating properties as part of an insulation and breakdown test, in particular by means of two electrodes flanking the structural unit and, further preferably, in a suspended state.

It may also be provided that the pipe arrangement and/or the said components are flushed, at least in sections, in a step y) to be carried out before step c). In this context, fluxing within the meaning of the disclosure refers to the application of a flux and/or another agent that has a positive effect on the soldering process, preferably preventing oxidation of the pipe arrangement and/or the aforementioned components during the soldering process. For example, the structural unit can be fluxed on an inner side, only on a section of the inner side, or preferably on a solder area of the inner side.

It is expediently provided that the structural unit is transported by means of an automated device for transporting the structural unit, preferably in a suspended state. This allows the structural unit to be transported, for example, from the continuous furnace to the press.

It may also be expedient to provide that one of the two components, preferably the first component, is or is designed as a connecting flange with a fluid inlet and a fluid outlet, and/or that one of the two components, preferably the second component, is or is designed as a deflection flange. The second openings of the pipe arrangement are conveniently connected to each other via the second component, which is designed as a deflection flange, so that, during normal operation of the temperature control segment, a fluid flowing into a first pipe or at least a first flow of the pipe arrangement is diverted via the deflection flange into a second pipe or at least a second flow of the pipe arrangement. Furthermore, the fluid inlet and fluid outlet of the aforementioned first component, implemented as a connecting flange, are expediently connected to the first openings of the pipe arrangement, so that a fluid can flow into a first pipe or at least a first flow of the pipe arrangement via the fluid inlet and flow out of a second pipe or at least a second flow of the pipe arrangement via the fluid outlet.

It may also be provided that, in step d), the pipe arrangement is given a profile, preferably a wave-shaped profile. The profile in question may have alternating wave crests and wave troughs along the central axis. In this case, the distance between two adjacent wave crests may preferably be identical. Similarly, the distance between two adjacent wave troughs may preferably be identical. The wave crests can be angular, trough-shaped, sinusoidal, oval, or round. The wave troughs can also be angular, trough-shaped, sinusoidal, oval, or round. It is also conceivable that the wave-shaped profile, in particular the angular, trough-shaped, sinusoidal, oval, or round wave troughs and the angular, trough-shaped, sinusoidal, oval, or round wave crests are adapted to an outer contour of the battery cells of the battery system, for example, round cylindrical round cells or prismatic battery cells, so that optimal contact and/or connection of the battery cells with a temperature control segment is possible. Furthermore, the wave crests along the respective central axis can have a first wave width and a first wave height oriented perpendicular thereto, and the wave troughs along the respective central axis can have a second wave width and a second wave height oriented perpendicular thereto. The first wave height and the second wave height are preferably identical, and/or the first wave width and the second wave width are identical.

The second task mentioned at the beginning is solved by a temperature control segment manufactured according to the method described above.

The third task mentioned at the beginning is solved by an inter-cell temperature control device for controlling the temperature of a battery system comprising several battery cells arranged one behind the other along a stack axis, comprising at least one temperature control segment or several temperature control segments connected to each other in a flow, which are designed in accordance with the preceding description or which are manufactured in accordance with the method explained above.

The fourth task mentioned at the beginning is solved by a battery system comprising several battery cells arranged one behind the other along a stacking axis, in particular round cylindrical round battery cells or prismatic battery cells, and temperature control segments arranged between two adjacent battery cells, preferably connected to each other in terms of flow and/or thermally contacted with the battery cells, of an inter-cell temperature control device designed in accordance with the preceding description for controlling the temperature of the battery system.

To summarize, it remains to be said: The present disclosure relates to a method for manufacturing a temperature control segment for controlling the temperature of a battery system, in which a pipe arrangement and components for fluid flow pre-fixed to the pipe arrangement are provided and, as part of a soldering treatment, preferably by means of a continuous furnace, so that a structural unit is formed, which is then formed in a subsequent forming treatment, preferably by means of a press. The disclosure further relates to a temperature control segment, an inter-cell temperature control device for controlling the temperature of a battery system, and a battery system.

Further important features and advantages of the disclosure will become apparent from the dependent claims, from the drawings, and from the associated description of the figures with reference to the drawings.

It is understood that the above-mentioned features and those yet to be explained below can be used not only in the combination indicated in each case, but also in other combinations or on their own, without deviating from the scope of the present disclosure. The above-mentioned components of a superordinate unit, such as a device, an apparatus, or an arrangement, which are designated separately, can form separate parts or components of this unit or be integral regions or sections of this unit, even if this is shown differently in the drawings.

Preferred exemplary embodiments of the disclosure are shown in the drawings and are explained in more detail in the following description, wherein identical reference numerals refer to identical or similar or functionally identical components.

### BRIEF DESCRIPTION OF THE DRAWINGS

They show, each schematically,

FIG. 1 shows a schematic representation of the proposed method for manufacturing a temperature control segment,

FIGS. 2 through 5 show a multiple stage forming process for a structural unit of the temperature control segment.

FIG. 6 shows a temperature control segment manufactured according to the proposed method, viewed from above.

FIG. 7 shows a detail of the temperature control segment from FIG. 6, viewed in the direction of arrow VII shown in FIG. 6, and

FIG. 8 shows another detail of the temperature control segment from FIG. 6, viewed in the direction of arrow VIII shown in FIG. 6.

### DETAILED DESCRIPTION

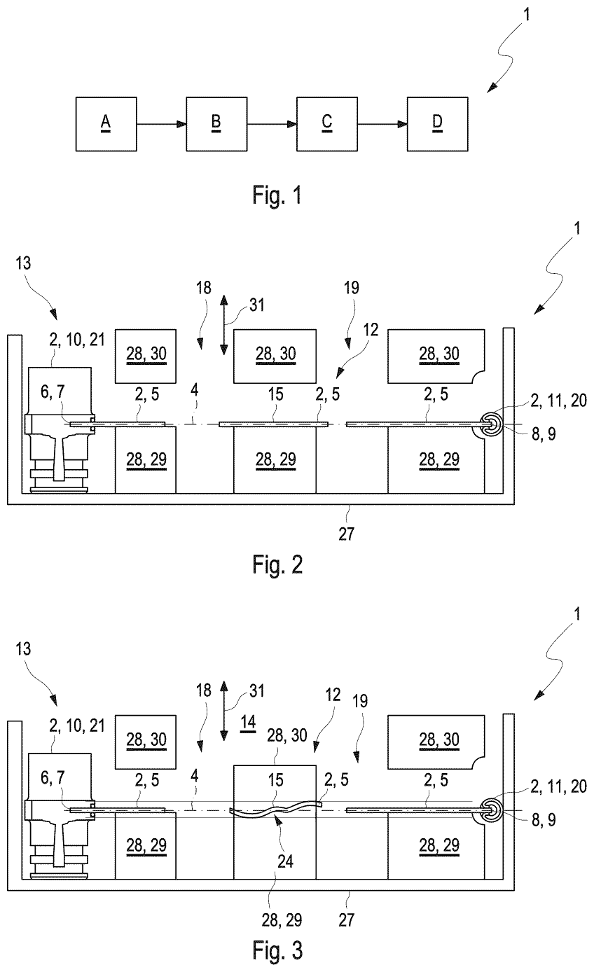

FIG. 1 illustrates a method 1 for manufacturing a temperature control segment 2, which is designed as a component of an unillustrated inter-cell temperature control device comprising several temperature control segments 2 connected to each other in a flow-connected manner, for controlling the temperature of a battery system comprising several battery cells arranged one behind the other along a stacking axis. The battery system may preferably be a traction battery installed in a vehicle.

As part of the proposed method 1, in a first step symbolized by box “A” in FIG. 1, a) provides for a pipe arrangement 5 extending along a central axis 4 and comprising at least two or more pipes, which has a first axial pipe end 6 with at least two first axial openings 7 and a second pipe end 8 axially opposite to this with at least two second axial openings 9. In this arrangement, a first opening 7 of the two openings 7 and a first second opening 9 of the two second openings 9 are assigned to a first, fluid-flowing flux 33 of the pipe arrangement 5, and a second opening 7 of the two openings 7 and a second opening 9 of the two second openings 9 are assigned to a second, fluid-flowing flux 34 of the pipe arrangement 5, see in particular FIGS. 2 and 6.

In a subsequent step b), symbolized by box “B” in FIG. 1, it is provided that two components 10, 11, which are designed to guide a fluid, are provided, wherein a first of the two components 10, 11 is arranged on the first pipe end 6, preferably by being pushed onto or inserted into the first pipe end 6, and is fixed to the same, preferably by caulking, and wherein a second of the two components 10, 11 is arranged on the second pipe end 8, preferably by being pushed onto or inserted into the second pipe end 8, and is fixed to the same, preferably by caulking. The fixing of the two components 10, 11 to the pipe arrangement 5 can be designed as a pre-fixing, in such a way that the two components 10, 11 are connected to the pipe arrangement 5 via only one or a few connection points or connection areas.

In a subsequent step c), symbolized by box “C” in FIG. 1, it is envisaged that the pipe arrangement 5 and the two components 10, 11 fixed to the pipe arrangement 5 fixed to the pipe assembly 5 are simultaneously soldered together and soft annealed as part of a soldering treatment, preferably by means of a continuous furnace, so that a coherent structural unit 12, through which a fluid can flow, preferably in a U-shape, is formed.

Finally, in step d), symbolized by box “D” in FIG. 1, it is provided that the structural unit 12, in particular only the pipe arrangement 5 of the structural unit 12, is plastically deformed as part of a forming treatment, preferably by means of a press 13. The forming treatment can be carried out in such a way that the structural unit 12 undergoes cold work hardening.

FIG. 2 shows a press 13 that can be used within the framework of the proposed method 1, with a frame 27 and several forming stations 28, wherein the forming stations 28 each have at least one holding jaw 29 fixed to the frame 27 and at least one adjusting jaw 30 adjustable in an adjusting direction 31 oriented transversely to the structural unit 12 or to its central axis 4 relative to the at least one holding jaw 29. The holding jaws 29 and the adjusting jaws 30 of the press 13 each have a jaw profile or a counter-jaw profile on their opposite jaw sides, so that, during normal operation of the press 13, when the press 13 is closed and the adjusting jaws 30 are moved toward the holding jaws 29 in the adjusting direction 31, thereby continuously reducing the gap between the adjusting jaws 30 and the holding jaws 29, a workpiece or a structural unit 12 positioned between the holding jaws 29 and the adjusting jaws 30 is formed and a profile specified by the jaw profiles or counter jaw profiles, in this case a wave-shaped profile 24, is transferred to the workpiece or the structural unit 12.

The structural unit 12 provided in step c) is, for example, placed or positioned on the holding jaws 29 in a suspended state or a horizontal state in such a way that the pipe arrangement 5 rests on the holding jaws 29 and the two components 10, 11 arranged on the pipe arrangement 5 protrude laterally beyond the press 13 and the holding jaws 29, respectively, at a distance.

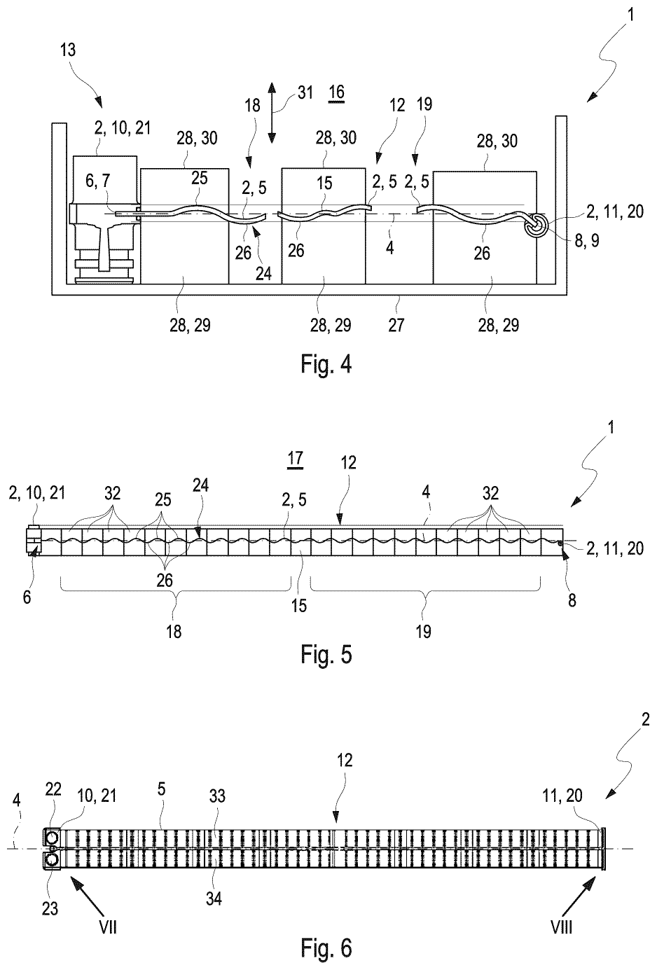

FIGS. 3 and 4 illustrate the forming treatment of structural unit 12 using the press 13 described in step d) of the proposed method 1, wherein the forming treatment is carried out in several stages, i.e., in several successive forming stages 14, 16, 17.

In a first forming stage 14 indicated in FIG. 3, a pipe center 15 of the pipe arrangement 5, which is formed by a section of the pipe arrangement 5 arranged centrally or substantially centrally between the two pipe ends 6, 8 of the pipe arrangement 5, is formed by means of one or more forming stations 28 and then the pipe arrangement 5 is fixed in place via its formed pipe center 15. The latter can be achieved, for example, by clamping the formed center 15 of the pipe arrangement 5, for example by means of a holding jaw 29 and an adjusting jaw 30 of at least one of the forming stations 28.

In a subsequent second forming stage 16, illustrated in FIG. 4, the pipe ends 6, 8 of the pipe arrangement 5 are first positioned correctly, preferably by calibrating the pipe ends 6, 8. This allows any distortion of the pipe arrangement 5 that may have occurred during the first forming stage 14 to be compensated for and a dimensionally accurate forming process to be achieved. Then the pipe ends 6, 8 of the pipe arrangement 5 are formed and the pipe arrangement 5 is fixed in place via its formed pipe ends 6, 8. The latter can be achieved, for example, by clamping the formed pipe ends 6, 8 of the pipe arrangement 5, for example by means of a holding jaw 29 and an adjusting jaw 30 of at least one of the forming stations 28.

In a subsequent third forming stage 17, which is not illustrated here, a first intermediate pipe section 18 of the pipe arrangement 5, which is formed by a section of the pipe arrangement 5 arranged axially between the first pipe end 6 and the pipe center 15, and a second intermediate pipe section 19 of the pipe arrangement 5, which is formed by a section of the pipe arrangement 5 arranged axially between the second pipe end 8 and the pipe center 15, are formed. The first intermediate pipe section 18 and the second intermediate pipe section 19 are each divided into several subsections 32, wherein a forming station 28 can be assigned to each subsection 32. The subsections 32 of the first intermediate pipe section 18 and the subsections 32 of the second intermediate pipe section 19 are formed simultaneously or sequentially during the third forming stage 17, resulting in the temperature control segment 2 illustrated in FIG. 5 with a pipe arrangement 5 having a wave-shaped profile 24.

FIGS. 6 through 8 illustrate a temperature control segment 2 manufactured according to the proposed method 1. It has the pipe arrangement 5 with a wave-shaped profile 24 and the components 10, 11 for fluid guidance arranged at the two axial pipe ends 6, 8 of the pipe arrangement 5. The pipe arrangement 5 is designed as a two-or multi-flow (i.e., two-or multi-channel) flat pipe, in particular a multi-port extrusion pipe (MPE pipe), which has, for example, a substantially rectangular cross-section. The wave-shaped profile 24 has alternating successive wave crests 25 and wave troughs 26, which in this case are sinusoidal in shape so that they can be easily arranged on round battery cells of a battery system.

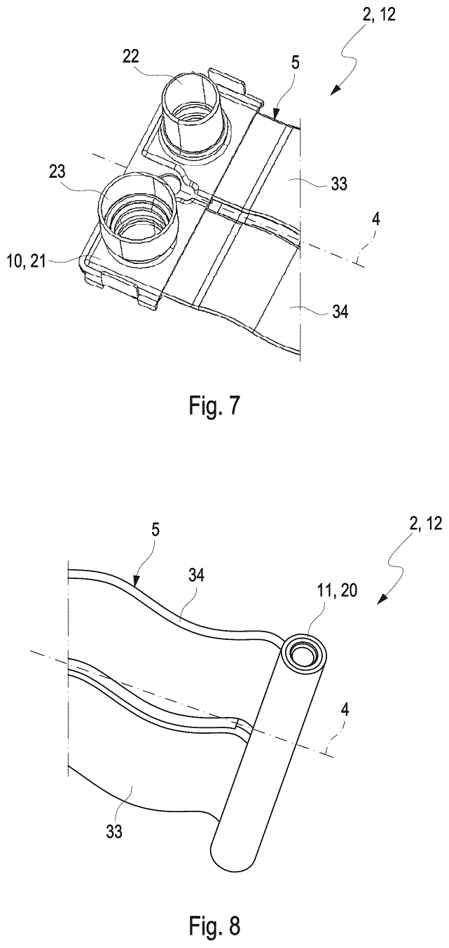

FIG. 7 shows that one (first) component 10 of the two components 10, 11 is designed as a connecting flange 21 with a nozzle-shaped fluid inlet 22 and a nozzle-shaped fluid outlet 23. This allows a fluid to flow into the first flow 33 of the pipe arrangement 5 via the fluid inlet 22 and flow out downstream via the fluid outlet 23 from the second flow 34 of the pipe arrangement 5.

FIG. 8 shows that a further (second) component 11 of the two components 10, 11 is designed as a deflection flange 20, thereby connecting the second axial openings 9 of the pipe arrangement 5 to each other via the further component 11. This allows the inflowing fluid to be diverted from the first flow 33 of the pipe arrangement 5 via the deflection flange 20 into the second flow 34 of the pipe arrangement 5 during normal operation of the temperature control segment 2.

Various examples/embodiments are described herein for various apparatuses, systems, and/or methods. Numerous specific details are set forth to provide a thorough understanding of the overall structure, function, manufacture, and use of the examples/embodiments as described in the specification and illustrated in the accompanying drawings. It will be understood by those skilled in the art, however, that the examples/embodiments may be practiced without such specific details. In other instances, well-known operations, components, and elements have not been described in detail so as not to obscure the examples/embodiments described in the specification. Those of ordinary skill in the art will understand that the examples/embodiments described and illustrated herein are non-limiting examples, and thus it can be appreciated that the specific structural and functional details disclosed herein may be representative and do not necessarily limit the scope of the embodiments.

Reference throughout the specification to “examples, “in examples,” “with examples,” “various embodiments,” “with embodiments,” “in embodiments,” or “an embodiment,” or the like, means that a particular feature, structure, or characteristic described in connection with the example/embodiment is included in at least one embodiment. Thus, appearances of the phrases “examples, “in examples,” “with examples,” “in various embodiments,” “with embodiments,” “in embodiments,” or “an embodiment,” or the like, in places throughout the specification are not necessarily all referring to the same embodiment. Furthermore, the particular features, structures, or characteristics may be combined in any suitable manner in one or more examples/embodiments. Thus, the particular features, structures, or characteristics illustrated or described in connection with one embodiment/example may be combined, in whole or in part, with the features, structures, functions, and/or characteristics of one or more other embodiments/examples without limitation given that such combination is not illogical or non-functional. Moreover, many modifications may be made to adapt a particular situation or material to the teachings of the present disclosure without departing from the scope thereof.

It should be understood that references to a single element are not necessarily so limited and may include one or more of such element. Any directional references (e.g., plus, minus, upper, lower, upward, downward, left, right, leftward, rightward, top, bottom, above, below, vertical, horizontal, clockwise, and counterclockwise) are only used for identification purposes to aid the reader's understanding of the present disclosure, and do not create limitations, particularly as to the position, orientation, or use of examples/embodiments.

“One or more” includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first element could be termed a second element, and, similarly, a second element could be termed a first element, without departing from the scope of the various described embodiments. The first element and the second element are both elements, but they are not the same element.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the phrase at least one of successive elements separated by the word “and” (e.g., “at least one of A and B”) is to be interpreted the same as the term “and/or” and as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Joinder references (e.g., attached, coupled, connected, and the like) are to be construed broadly and may include intermediate members between a connection of elements, relative movement between elements, direct connections, indirect connections, fixed connections, movable connections, operative connections, indirect contact, and/or direct contact. As such, joinder references do not necessarily imply that two elements are directly connected/coupled and in fixed relation to each other. Connections of electrical components, if any, may include mechanical connections, electrical connections, wired connections, and/or wireless connections, among others. Uses of “e.g.” and “such as” in the specification are to be construed broadly and are used to provide non-limiting examples of embodiments of the disclosure, and the disclosure is not limited to such examples.

While processes, systems, and methods may be described herein in connection with one or more steps in a particular sequence, it should be understood that such methods may be practiced with the steps in a different order, with certain steps performed simultaneously, with additional steps, and/or with certain described steps omitted.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context. All matter contained in the above description or shown in the accompanying drawings shall be interpreted as illustrative only and not limiting. Changes in detail or structure may be made without departing from the present disclosure.

1. A method for manufacturing a temperature control segment for a battery system, the method comprising:
providing a pipe arrangement extending along a central axis and comprising at least two channels, the pipe arrangement including a first axial pipe end with at least two first axial openings and a second axial pipe end opposite the first axial pipe end with at least two second axial openings;
providing at least two fluid-conducting components;
arranging a first component of the at least two fluid-conducting components on the first pipe end and fixing the first component to the first pipe end;
arranging a second component of the at least two fluid-conducting components on the second pipe end and fixing the second component to the second pipe end;
simultaneously soldering the pipe arrangement and the at least two fluid-conducting components together and soft annealing the pipe arrangement and the at least two fluid-conducting components to form a coherent structural unit; and
plastically forming the coherent structural unit.

2. The method of claim 1, wherein fixing the first component to the first pipe end and fixing the second component to the second pipe end comprises caulking.

3. The method of claim 1, wherein:
arranging the first component comprises pushing the first component onto or inserting the first component into the first pipe end, and/or
arranging the second component comprises pushing the second component onto or inserting the second component into the second pipe end.

4. The method of claim 1, wherein the soldering and soft annealing are performed in a continuous furnace, and/or wherein the coherent structural unit defines a U-shaped fluid flow path.

5. The method of claim 1, wherein plastically forming the coherent structural unit comprises cold forming.

6. The method of claim 1, wherein plastically forming the coherent structural unit is performed using a press.

7. The method of claim 1, wherein plastically forming the coherent structural unit comprises plastically deforming only the pipe arrangement of the coherent structural unit.

8. The method of claim 1, wherein plastically forming the coherent structural unit is carried out in multiple stages.

9. The method of claim 8, wherein the multiple stages comprise:
a first forming stage wherein a pipe center of the pipe arrangement is formed and the pipe arrangement is fixed in place at the formed pipe center, the pipe center being arranged centrally between the first and second pipe ends;
a second forming stage wherein the first and second pipe ends are positioned correctly and formed, and the pipe arrangement is fixed in place via the formed first and second pipe ends; and
a third forming stage wherein a first intermediate pipe section arranged axially between the first pipe end and the pipe center is formed, and/or wherein a second intermediate pipe section arranged axially between the second pipe end and the pipe center is formed.

10. The method of claim 1, wherein:
the structural unit is formed in a suspended state, or
the structural unit is reshaped in a horizontal position.

11. The method of claim 1, further comprising performing a leak test on the structural unit after plastically forming the structural unit.

12. The method of claim 11, further comprising applying at least one coating to the coherent structural unit after the leak test.

13. The method of claim 12, further comprising testing the structural unit for insulating properties as part of an insulation and breakdown test after the leak test or applying the at least one coating.

14. The method of claim 1, further comprising flushing the pipe arrangement or the at least two fluid-conducting components at least in sections before the simultaneous soldering.

15. The method of claim 1, wherein the structural unit is transported by an automated transport device.

16. The method of claim 1, wherein:
one of the at least two fluid-conducting components comprises a deflection flange, and/or
one of the at least two fluid-conducting components comprises a connecting flange having a fluid inlet and a fluid outlet.

17. The method of claim 1, wherein the pipe arrangement is provided with a wave-shaped profile having alternating successive wave crests and wave troughs along the central axis.

18. A temperature control segment manufactured according to the method of claim 1.

19. An inter-cell temperature control device for controlling the temperature of a battery system, the device comprising:
at least one temperature control segment manufactured according to the method of claim 1.

20. A battery system comprising:
a plurality of battery cells arranged one behind the other along a stacking axis; and [symbol]
